(19) United States
(12) Patent Application Publication
(10) Pub. No.: US 2021/0390344 A1
(43) Pub. Date: Dec. 16, 2021

(54) AUTOMATICALLY APPLYING STYLE CHARACTERISTICS TO IMAGES

(71) Applicant: ELEMENT AI INC., Montreal (CA)

(72) Inventors: Pegah KAMOUSI, Montreal (CA); Jaehong PARK, Montreal (CA); Perouz TASLAKIAN, Montreal (CA)

(73) Assignee: ELEMENT AI INC., Montreal, QC (CA)

(21) Appl. No.: 17/290,321

(22) PCT Filed: Oct. 31, 2019
(86) PCT No.: PCT/CA2019/051543

§ 371 Date: Apr. 30, 2021

Related U.S. Application Data
(60) Provisional application No. 62/754,019, filed on Nov. 1, 2018.

(51) Int. Cl. G06K 9/62; G06T 5/00; G06T 7/90; G06N 20/00

(52) U.S. Cl. CPC G06K 9/6256; G06T 5/007; G06T 2207/30176; G06N 20/00; G06T 2207/20084; G06T 7/90

(57) ABSTRACT

Systems and methods for automatically applying style characteristics to images. The images may comprise text. Additionally, the images may be synthetically generated. A style template containing information about style characteristics is passed to an extraction module, which extracts that information and thus determines the style characteristics. The style characteristics are then passed to an application module, which also receives an input image. The application module applies the style characteristics to the image, thereby producing an output image in the intended style. The extraction module and the application module may comprise machine learning elements. The output image may be used in later processes, including, among others, in training processes for optical character recognition models.

### TECHNICAL FIELD

The present invention relates to image processing. More specifically, the present invention relates to automatically applying predetermined styles to images.

### BACKGROUND

Optical character recognition (OCR) is today a field of great interest. As is well-known, OCR is a process in which text is digitally encoded based on digital images containing that text. The text may be printed or typed, and in some cases even handwritten. OCR techniques are used in digital data entry, text mining, and many other machine reading applications.

Training machine-learning systems to perform OCR, however, requires significant amounts of data, generally in the form of text-containing images. However, such data objects are often difficult to obtain. Text-containing images taken in the real world may be subject to complex legal issues, may contain proprietary or personally identifying information, and/or may be quite expensive.

Thus, many OCR applications are currently trained on synthetic images, which are machine-generated rather than traditionally captured. Many systems exist for creating synthetic images of text. Unfortunately, however, the synthetic images produced are frequently too ‘clean’ as in they lack the artefacts and imperfections of real-world images—these synthetic images lack the visual complexity of the real-world images. As an example, real-world images of text are frequently discoloured, or show damaged or wrinkled documents, synthetically generated images tend to look perfect. This means that OCR models and other applications that use these synthetic images as training data struggle to adapt to the messier (and more realistic) real-world images.

Thus, there is a need for systems and methods that can introduce the characteristics of real-world data, i.e., the imperfections, wrinkles, shades, etc. of real-world images into synthetically generated images. That is, there is a need for systems and methods that can introduce broad ‘style characteristics’ into an image. Preferably, these systems and methods are automatic and self-improving.

### SUMMARY

The present invention provides systems and methods for automatically applying style characteristics to images. The images may comprise text. Additionally, the images may be synthetically generated. A style template containing information about style characteristics is passed to an extraction module, which extracts that information and thus determines the style characteristics. The style characteristics are then passed to an application module, which also receives an input image. The application module applies the style characteristics to the image, thereby producing an output image in the intended style. The extraction module and the application module may comprise machine learning elements. The output image may be used in later processes, including, among others, in training processes for optical character recognition models.

In a first aspect, the present invention provides a method for automatically applying style characteristics to an image, the method comprising:
(a) receiving a style template, said style template containing information related to said style characteristics;
(b) determining said style characteristics based on said information;
(c) receiving said image;
(d) applying said style characteristics to said image to thereby produce an output image.

In a second aspect, the present invention provides a system for automatically applying style characteristics to an image, the system comprising:
an extraction module for receiving a style template, wherein said style template contains information related to said style characteristics; and for determining said style characteristics based on said information; and
an application module for receiving said image, and for applying said style characteristics to said image to thereby produce an output image.

In a third aspect, the present invention provides non-transitory computer-readable media having encoded thereon computer-readable and computer-executable instructions that, when executed, implement a method for automatically applying style characteristics to an image, the method comprising:
(a) receiving a style template, said style template containing information related to said style characteristics;
(b) determining said style characteristics based on said information;
(c) receiving said image;
(d) applying said style characteristics to said image to thereby produce an output image.

### BRIEF DESCRIPTION OF THE DRAWINGS

The present invention will now be described by reference to the following figures, in which identical reference numerals refer to identical elements and in which:

FIG. 1 is a block diagram of a system according to one aspect of the invention;

FIG. 2 shows an input image for the system of the invention and several output images based on that input image;

FIG. 3 shows a synthetic image, distorted according to an embodiment of the method of the invention;

FIG. 4 shows another synthetic image, distorted according to an embodiment of the method of the invention;

FIG. 5 shows another synthetic image, distorted according to an embodiment of the method of the invention;

FIG. 6 shows another synthetic image, distorted according to an embodiment of the method of the invention;

FIG. 7A shows the results of an OCR process on a section of a synthetic image;

FIG. 7B shows the image section of FIG. 7A after the image has been distorted;

FIG. 8A shows the results of an OCR process on a section of a synthetic image to which style characteristics were applied;

FIG. 8B shows the image section of FIG. 8A after an OCR process with different style characteristics applied;

FIG. 8C shows the image section of FIG. 8A after an OCR process with different style characteristics applied;

FIG. 9A shows an undistorted synthetic image containing text that has been labeled by an OCR process;

FIG. 9B shows the text of FIG. 9A with a background and distortions applied;

FIG. 9C shows the image of FIG. 9B with labels determined by an OCR process;

FIG. 10A shows a synthetic image distorted according to an embodiment of the method of the invention;

FIG. 10B shows the image of FIG. 10A with OCR labels applied; and

FIG. 11 is a flowchart detailing a method according to an aspect of the invention.

### DETAILED DESCRIPTION

The present invention provides automatic systems and methods for applying style characteristics to an image. In one embodiment, style characteristics of real-world images may be applied to synthetically generated images, which can then be used in later processing. Such an embodiment would reduce the need for obtaining potentially costly and complicated real-world data.

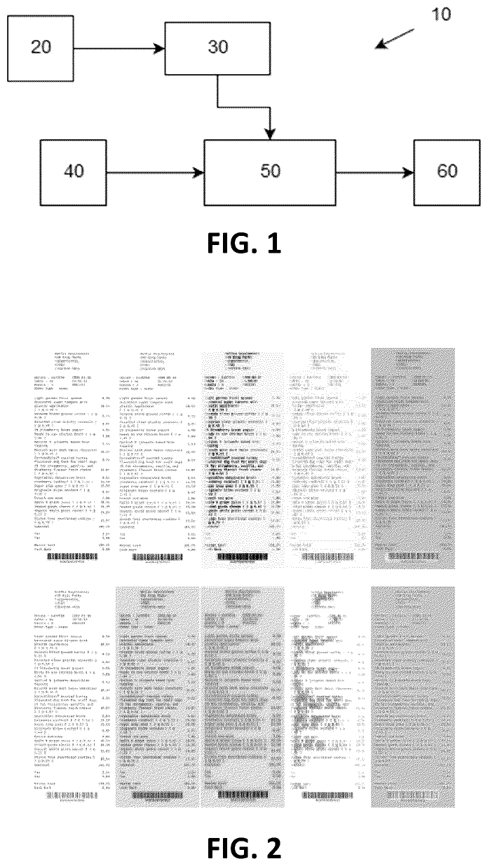

FIG. 1 is a block diagram showing a system 10 according to one aspect of the invention. The system 10 takes a style template 20 as input to an extraction module 30. The style template 20 is a data object comprising information related to the style characteristics that are to be applied. The extraction module 30 extracts this information from the style template 20 and thus determines what style characteristics to apply to an image 40. The image 40 is received by an application module 50, which also receives the determined characteristics from the extraction module 30. The application module 50 then applies those determined style characteristics to the image 40, thereby producing an output image 60.

Style characteristics may include a variety of characteristics related to the image 40. For instance, a style characteristic may be an image colour or a colour level (such as, ‘increased yellow colour in all pixels’). Another style characteristic may be a contrast level for the image 40 or a saturation level. Additionally, style characteristics may be related to a level of distortion (for instance, a level of blurriness or sharpness) intended for the image 40. Other distortions indicated by style characteristics may include ‘folding’, ‘creasing’, or ‘wrinkling’ the image. These style characteristics may be applied over the entire image 40, or over sections of that image.

Additionally, as would be understood, multiple style characteristics may be applied to a single image 40. That is, a single image may be ‘yellowed’, ‘blurred’, and ‘folded’ to better represent possible real-world images. Alternatively, an image may have only one style characteristic applied. For instance, a single colour change might represent poor lighting conditions in the real world. The predetermined style template 20 thus may contain information related to one or more style characteristics.

The style template 20 may take many forms. In one embodiment, the style template 20 is a template image that has the desired ‘style’, such as a real-world image with desirable contrast levels or blurriness. In such an embodiment, the extraction module 30 would determine the style characteristics based on an analysis of that template image. In another embodiment, the style template 20 may simply be a list of style characteristics encoded in a usable and convenient format. In a further embodiment, the style template 20 may be the result of a machine learning or training process—that is, the extraction module 30 may use machine learning methods to generate the style template 20 based on other training data, which may include real-world images.

In some embodiments, the extraction module 30 and application module 50 may comprise rules-based elements. However, it may be difficult to prepare rules in advance for all possible images that may be received. Thus, in some embodiments, it may be preferable to use machine learning units in the system 10. Either or both of the extraction module 30 and the application module 50 may thus comprise machine learning elements, including neural network-based elements.

Further, in some embodiments, the functions of the extraction module 30 and the application module 50 may be performed by a single module. In an embodiment using machine learning, the module(s) may be trained using a predetermined style template 20. Alternatively, the module(s) may be untrained at start and merely given a set of template images from which to generate a style template 20.

A kind of neural network known as adversarial networks (and in particular, generative adversarial networks or “GANs”) are well-suited to such tasks. For greater detail on the mechanics of GANs, see Liu, Breuel, and Kautz, “Unsupervised Image-to-Image Translation Networks”, arXiv:1703.00848v6 [cs.CV], July 2018, and Zhu et al, “Unpaired Image-to-Image Translation using Cycle-Consistent Adversarial Networks”, arXiv:1703.10593v5 [cs.CV], August 2018.

### EXAMPLES

Several tests were performed using a system based on GAN elements. Various input and output images from these tests will now be discussed. Referring to FIG. 2, ten versions of the same image are shown. The image in the top left of the figure was the original input image 40. This image is a synthetically generated receipt. The remaining nine images in FIG. 2 were produced by applying various style characteristics to this original input image. As can be seen, some of these changes included altering the overall colour of the image, while some involved increasing the ‘blurriness’ of the text. Again, in some of the images, multiple style characteristics were applied together.

In these tests, each style was applied by using a different model. However, various configurations and architectural modifications of the same underlying model could also be used to generate multiple different styles. For instance, a model could be configured with several style templates. In such a case, a single model could produce multiple output images 60 from a single input image 40. Alternatively, this single model could be configured to select a different known style for each input image 40. This selection could be random or directed by another process or a user.

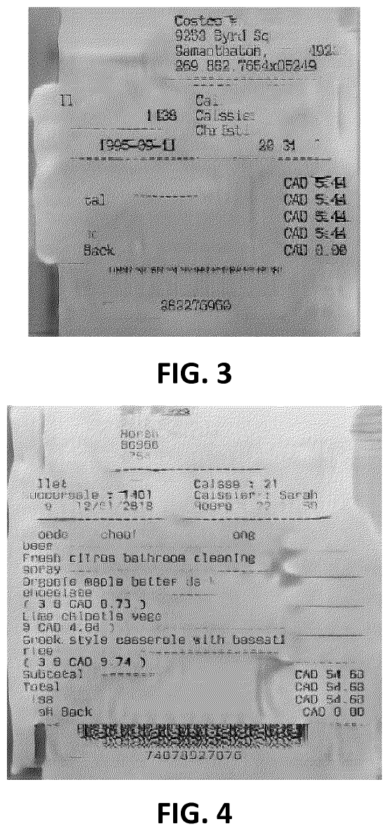

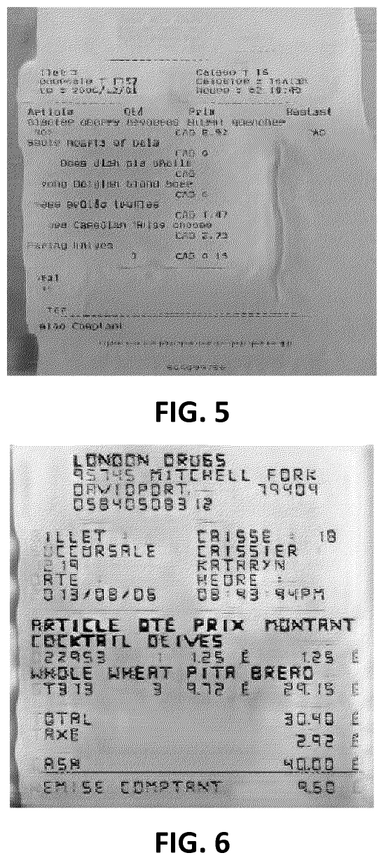

FIG. 3 shows an output image from another test. In this test, as can be seen, the style characteristics that were applied to a synthetic image of a receipt included blurring the text characters and applying “wrinkle-type” distortions to the image. FIGS. 4 to 6, likewise, show various synthetic receipts with blurring, smearing, and wrinkling distortions. These distortions mimic what might be expected in real-world images.

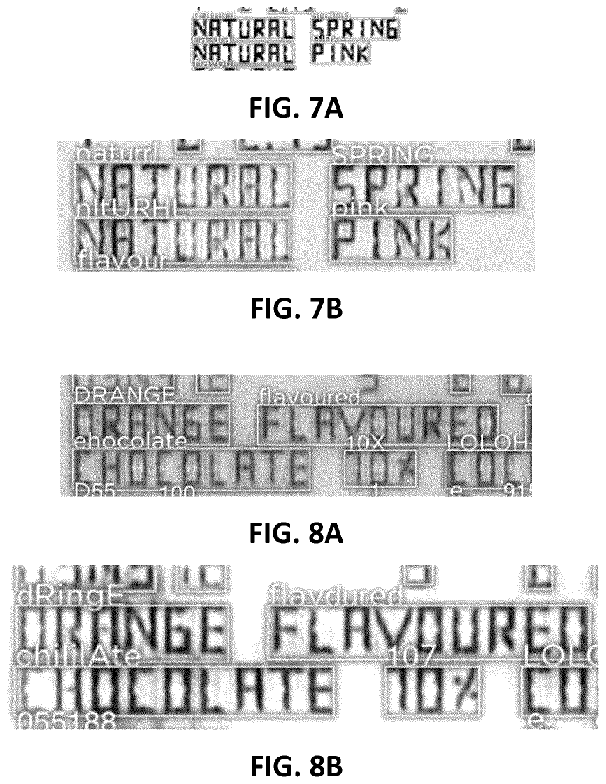

FIG. 7A shows a section of a synthetically generated and undistorted text-containing image that has been labeled using an OCR process. As can be seen, in this image, each label accurately corresponds to the text it represents (that is, the label for the text “PINK” is ‘pink’ and so on). FIG. 7B shows the results of an OCR process on the same image section after style characteristics such as fading have been applied. This style change reveals weaknesses in the OCR process: as can be seen, the labels for “NATURAL” are both incorrect (‘naturrl’ and ‘nitURHL’, respectively). Such results can demonstrate areas for OCR and other processes to improve and increase their robustness when faced with ‘messy’ data and images.

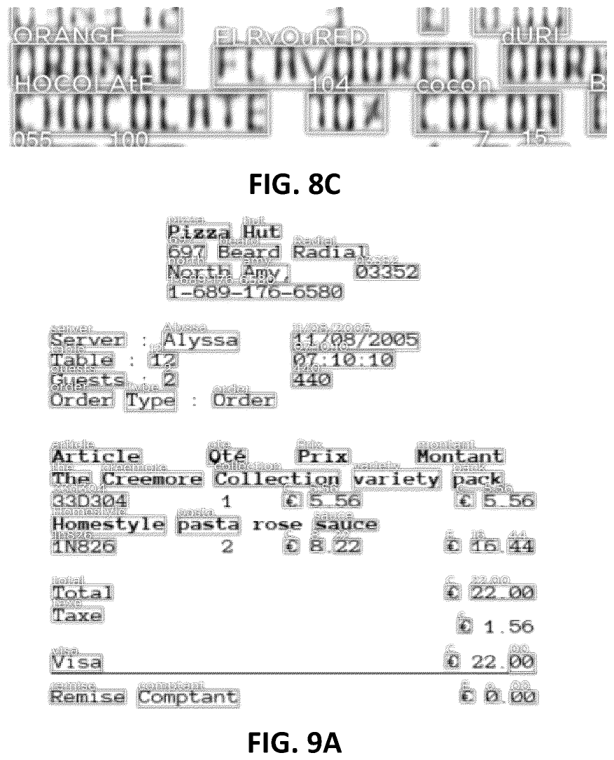

FIGS. 8A to 8C, similarly, show OCR results on various sections of distorted synthetic text-containing images. Each of these figures shows an image with a different set of style characteristics applied. As can be seen, the different style characteristics lead to different OCR results for each image.

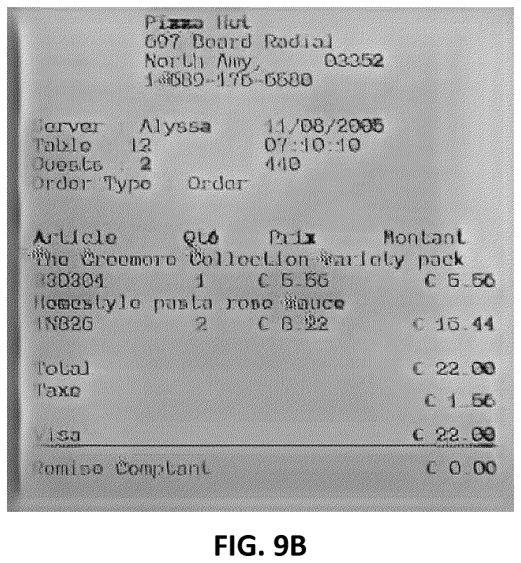

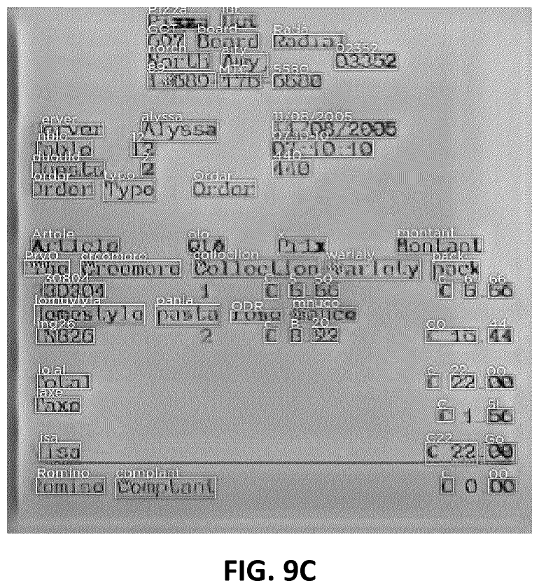

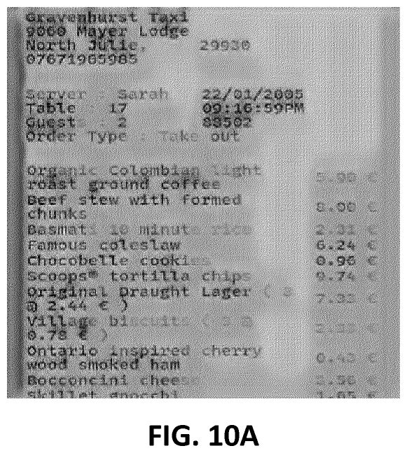

FIG. 9A shows synthetically generated text for a receipt image. This text is undistorted and presented without a background image. Labels for this text have been applied by an OCR process: as can be seen, all of these labels accurately correspond to the text they represent. FIG. 9B shows the text of FIG. 9A superimposed on a background image, which was then distorted. (Of course, as would be understood, the use of synthetic receipt data was merely a convenience in testing. Any kind of text-containing image may be used by the present invention.) FIG. 9C shows the image of FIG. 9B with labels from an OCR process applied. As can be seen, many of the labels are correct. However, the OCR process struggled to identify several blurred and distorted test elements (for instance, the OCR label for “Article” was ‘Artole’). The differences between the label sets in FIGS. 9A and 9C show the benefit of using distorted images to train OCR and other processes.

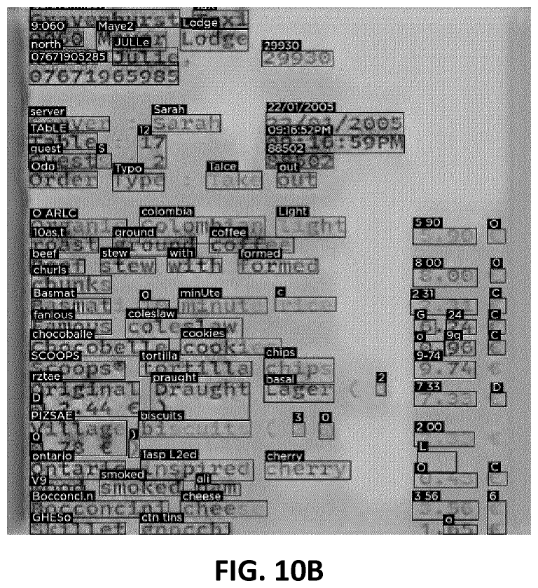

FIGS. 10A and 10B similarly show distorted synthetic receipt images. FIG. 10B shows the results of an OCR process on the image in FIG. 10A. Again, not all of the applied labels are accurate, due to the distortions and style changes to the image.

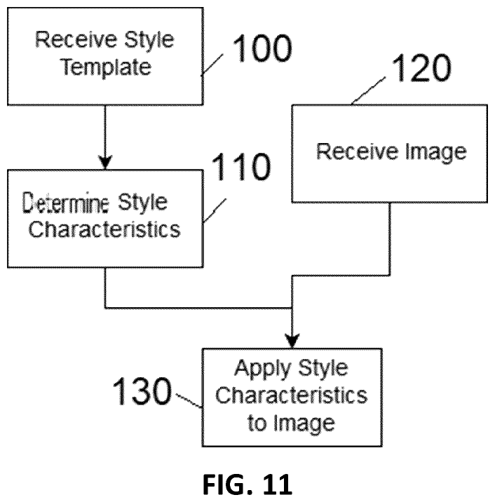

Referring now to FIG. 11, a flowchart detailing a method according to one aspect of the invention is illustrated. At step 100, a style template is received. Then, at step 110, the style characteristics represented by the style template are determined. At step 120, an image is received. At step 130, the style characteristics are applied to the image. Note that step 120 may be performed at any point before step 130 (that is, the method does not require step 120 to follow steps 100-110). However, both step 110 and step 120 must be completed to perform step 130.

Additionally, as discussed above, the style template may take many forms and a single style template may be reused many times, for many different images. Thus, steps 120-130 may be repeated many times with many images, without repeating steps 100-110. Likewise, many different style templates may be used with a single input image.

As would be understood, the output data produced by the present invention may be used for training OCR processes. However, the present invention may also be used in many other applications. In particular, the present invention may be configured for any application that would benefit from using a larger data set. As examples, the present invention may be configured for an application for which data is difficult or costly to obtain, or for which synthetic data is too ‘clean’, or for which a specific style of data is desirable.

Additionally, it should be noted that the term ‘image’, as used herein, is not exclusive to 2D images. Various other forms of data may be used by the present invention. For instance, the present invention may receive 3D image data, video data, medical imaging data, video game data, or any other kind of single-dimensional or multi-dimensional data that would be suitable for the application of style characteristics.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for automatically applying style characteristics to an image, the method comprising:
(a) receiving a style template, said style template containing information related to said style characteristics;
(b) determining said style characteristics based on said information;
(c) receiving said image;
(d) applying said style characteristics to said image to thereby produce an output image.

2. The method according to claim 1, wherein said information comprises at least one of: a contrast level; a colour level; a saturation level; and a distortion level.

3. The method according to claim 1, wherein said image is synthetically created.

4. The method according to claim 1, wherein said method is performed using at least one machine-learning unit.

5. The method according to claim 1, wherein specific style characteristics from a single style template are applied to multiple images.

6. The method according to claim 1, wherein said image comprises text.

7. The method according to claim 1, wherein said output image is added to a data set to be used in later processing.

8. A system for automatically applying style characteristics to an image, the system comprising:
an extraction module for receiving a style template, wherein said style template contains information related to said style characteristics; and for determining said style characteristics based on said information; and
an application module for receiving said image, and for applying said style characteristics to said image to thereby produce an output image.

9. The system according to claim 8, wherein said information comprises at least one of: a contrast level; a colour level; a saturation level; and a distortion level.

10. The system according to claim 8, wherein said image was synthetically created.

11. The system according to claim 8, wherein said method is performed using at least one machine-learning unit.

12. The system according to claim 8, wherein specific style characteristics from a single style template are applied to multiple images.

13. The system according to claim 8, wherein said image comprises text.

14. The system according to claim 8, wherein said output image is added to a data set to be used in later processing.

15. Non-transitory computer-readable media having encoded thereon computer-readable and computer-executable instructions that, when executed, implement a method for automatically applying style characteristics to an image, the method comprising:
(a) receiving a style template, said style template containing information related to said style characteristics;
(b) determining said style characteristics based on said information;
(c) receiving said image;
(d) applying said style characteristics to said image to thereby produce an output image.

16. The computer-readable media according to claim 15, wherein said information comprises at least one of: a contrast level; a colour level; a saturation level; and a distortion level.

17. The computer-readable media according to claim 15, wherein said image was synthetically created.

18. The computer-readable media according to claim 15, wherein said method is performed using at least one machine-learning unit.

19. The computer-readable media according to claim 15, wherein specific style characteristics from a single style template are applied to multiple images.

20. The computer-readable media according to claim 15, wherein said image comprises text.

21. The computer-readable media according to claim 15, wherein said output image is added to a data set to be used in later processing.
